(19) United States
(12) Patent Application Publication
(10) Pub. No.: US 2009/0044441 A1
(43) Pub. Date: Feb. 19, 2009

(54) SNAP TERMINAL TACKLE

(76) Inventors: Ryan Neal, Claremore, OK (US); Micah Jones, Jenks, OK (US); Greg Trees, Columbus, OH (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/837,599

(22) Filed: Aug. 13, 2007

(51) Int. Cl. A01K 91/04; A01K 83/00

(52) U.S. Cl. 43/44.83; 43/43.1

(57) ABSTRACT

A device for affixing terminal tackle to a fishing line has a body that defines a chamber, an upper orifice, and a lower orifice. A winding member is located within the body and defines a circumferential groove. Terminal tackle is affixed to the winding member. Fishing line passes through the upper and lower orifices. The winding member rotates within the body for displacing a path of the line from the upper to the lower orifice for forcing line into the groove and for wrapping line around the winding member for increasing line/winding member contact area for securing the tackle onto the line. A pinch point may be provided to further secure line within the body. Tactile feedback is provided to alert when the winding member is rotated to a pre-determined rotational position. Anti-backdrive mechanisms are provided to prevent unwanted rotation of the winding member when tension is applied to the line.

### FIELD OF THE INVENTION

The present invention relates to a device for fastening and unfastening objects to a fishing line, and is particularly adapted for attachment of fishing line accessories, such as bobbers, sinkers, lures, and hooks to a fishing line.

### BACKGROUND OF THE INVENTION

Recreational fishing is a popular pastime for many. Typically, recreational fishing is conducted with a rod, reel, line, hooks and any one of various types of baits or lures. Other devices, commonly referred to as terminal tackle, are also used to assist in presenting the bait to the targeted fish. Some examples of terminal tackle include weights, floats, swivels, bobbers, sinkers, and other devices. For purposes of this application, hooks, baits, and lures will also be referred to as terminal tackle.

The typical method of attaching terminal tackle to fishing line is by tying a knot in the fishing line. A variety of different kinds of knots are used in specific situations and for particular types of line. There are many variables that determine what type of knot should be used.

Different types of fishing line may support a variety of knots but not all lines and knots are ideal in combination. Examples of types of line include braid, monofilament, sometimes referred to as spectra, and fluorocarbon. Examples of popular knots used for fishing include uni-knots, clinch knots, swivel knots and Palomar knots.

Many of the knot and line variables will be unknown to the casual and beginning fisherman. Additionally, even if a fisherman has appropriate knowledge, it is possible that a fisherman may not have the dexterity required to effectively tie functional knots. Further, incorrectly selecting or ineffectively tying a particular knot may result in the loss of a potential catch or in a loss of bait, which diminishes fishing enjoyment and may be discouraging.

Therefore, it is desirable to provide a device that will allow anyone to easily and securely attach terminal tackle to a fishing line without having to master the ability to tie or select an appropriate knot.

### SUMMARY OF THE INVENTION

The present invention is directed to a snap tackle device to provide a fisherman with the ability to easily attach to a fishing line a fish hook, bobber, sinker, lure, or other fishing device, the sum of which is referred to as terminal tackle throughout this disclosure. The present invention will provide the user with the ability to create an attachment of terminal tackle to any fishing line in a manner that requires less finger dexterity and less time than current alternatives.

Further, the present invention facilitates a superior strength of attachment as compared to standard knots, which are typically rated to a limit less than 100% of a rated line strength.

Additionally, the snap terminal tackle of the present invention may be more easily removed or adjusted relative to an original attaching location of terminal tackle on the fishing line. Current methods typically require the user to remove fishing line from the terminal tackle by cutting the line and re-attaching the tackle with a knot. By using the terminal tackle of the invention, the line will not be required to be cut.

An additional benefit is that the snap tackle of the present invention eliminates a need for using a secondary means to achieve smoothness in line attachment, such as super glue, which is often used, as is explained below. Knots can become a burden to the user since knots create a bulge relative to the line circumference that can catch on external items such as line guides, weeds, sticks, etc. The ability to consistently tie a knot that does not present this problem may be difficult for a user since tying an ideal knot requires learning and practice. Consequently, users often use the aid of a secondary means such as super glue to smooth out the bulge created by the knot. The present invention has a smooth external body which is always the same, thus minimizing the problem of snagging line for the user.

A common problem in fishing is that there are many types of lines and that each type has different material behavior. For example, common mono-filament lines absorb water and stretch proportional to the amount of force applied to the line. When stretched, the circumference of the line will change. These variations in line properties create variations in knot properties that can be detrimental to the utility of the knot. It is desirable to eliminate the need of a user to understand these properties by using this invention, which provides consistent results regardless of the line type.

As can be seen from the above description, the snap terminal tackle of the invention is provided to will allow anyone to easily, consistently and securely attach terminal tackle to a fishing line without having to master the ability to tie or select an appropriate knot.

### BRIEF DESCRIPTION OF THE DRAWINGS

FIG. 1 is a perspective view of one embodiment of the snap terminal tackle of the invention.

FIG. 2 is an exploded top perspective view of the snap terminal tackle device of FIG. 1.

FIG. 3 is an exploded bottom perspective view of the snap terminal tackle device of FIG. 1.

FIG. 4 is a partial cross-sectional view of the snap terminal tackle device of FIG. 1.

FIG. 5 is a plan view of a first embodiment of lower housing member of the snap terminal tackle device shown in FIG. 1 of the capstan of FIGS. 6a and 6c wherein the spring member is shown engaging one of a plurality of recesses defined by said lower housing.

FIG. 6a is an elevation view of a first embodiment of the capstan and attached terminal tackle of the snap terminal tackle device of FIG. 1.

FIG. 6b is a plan view of the capstan of FIG. 6a.

FIG. 6c is an elevation view of a first embodiment of the capstan and attached terminal tackle of a first embodiment of the snap terminal tackle device of FIG. 1.

FIG. 6d is a plan view of the capstan of FIG. 6c.

FIG. 6e is an elevation view of a second embodiment of the capstan and attached terminal tackle of a first embodiment of the snap terminal tackle device of FIG. 1.

FIG. 6f is a second elevation view of FIG. 6e.

FIG. 7 is a plan view of a second embodiment of the capstan and attached terminal tackle device shown in FIG. 1 wherein the lower housing is shown with the capstan loaded into the internal cavity.

FIG. 8 is a perspective view showing a first embodiment of the snap terminal device of FIG. 1 in a loading position, with fishing line inserted therein.

FIG. 8b is a perspective view showing a first embodiment of the snap terminal device of FIG. 1 in a loading position, with fishing line inserted therein.

FIG. 8c is a perspective view showing a first embodiment of the snap terminal device of FIG. 1 in an intermediate position wherein the fishing line is displaced from a straight orientation.

FIG. 8d is a perspective view showing a first embodiment of the snap terminal tackle device of FIG. 1 in a locked position wherein the fishing line is received within grooves and extends out of a typical end of the lower groove to facilitate a pinch point.

FIG. 9 is a perspective view of a capstan of a third embodiment of a snap terminal tackle device.

FIG. 10 is an elevational view of the capstan of FIG. 9.

FIG. 11 is an end view of the capstan of FIG. 9.

FIG. 12 is a plan view of the third embodiment of the snap terminal tackle device in a open position.

FIG. 13 is a cross-sectional view of the third embodiment of the snap terminal tackle device of FIG. 12 shown in an open position and taken along lines 13-13 of FIG. 12.

FIG. 14 is a cross-sectional view of the third embodiment of the snap terminal tackle device of FIG. 12 taken along line 14-14 of FIG. 12.

FIG. 15 is a cross-sectional view of the third embodiment of the snap terminal tackle device of FIG. 12 shown in a locked position and taken along line 15-15 of FIG. 12.

FIG. 16 is a front view of the snap terminal tackle device of FIG. 12.

FIG. 17 is a side elevation view of the snap terminal tackle device of FIG. 12 shown in an open position.

FIG. 18 is a front elevation view of the snap terminal tackle device of FIG. 12 shown in a closed position.

FIG. 19 is a side elevation view of the snap terminal tackle device of FIG. 12 shown in a closed position.

### DETAILED DESCRIPTION OF THE PREFERRED EMBODIMENTS

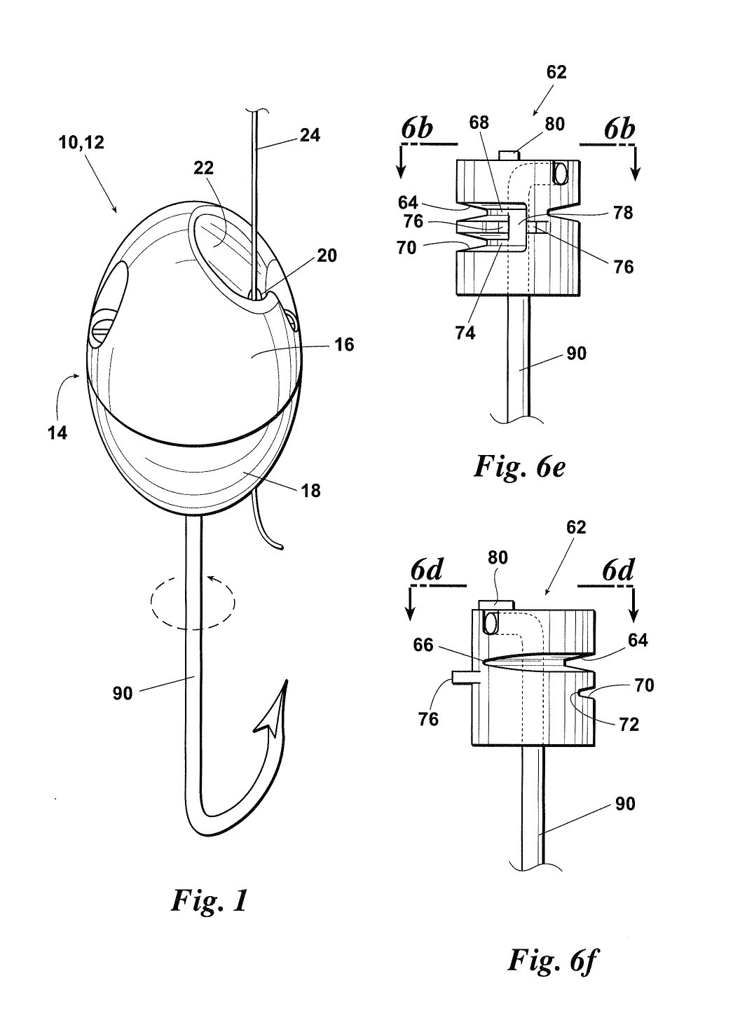

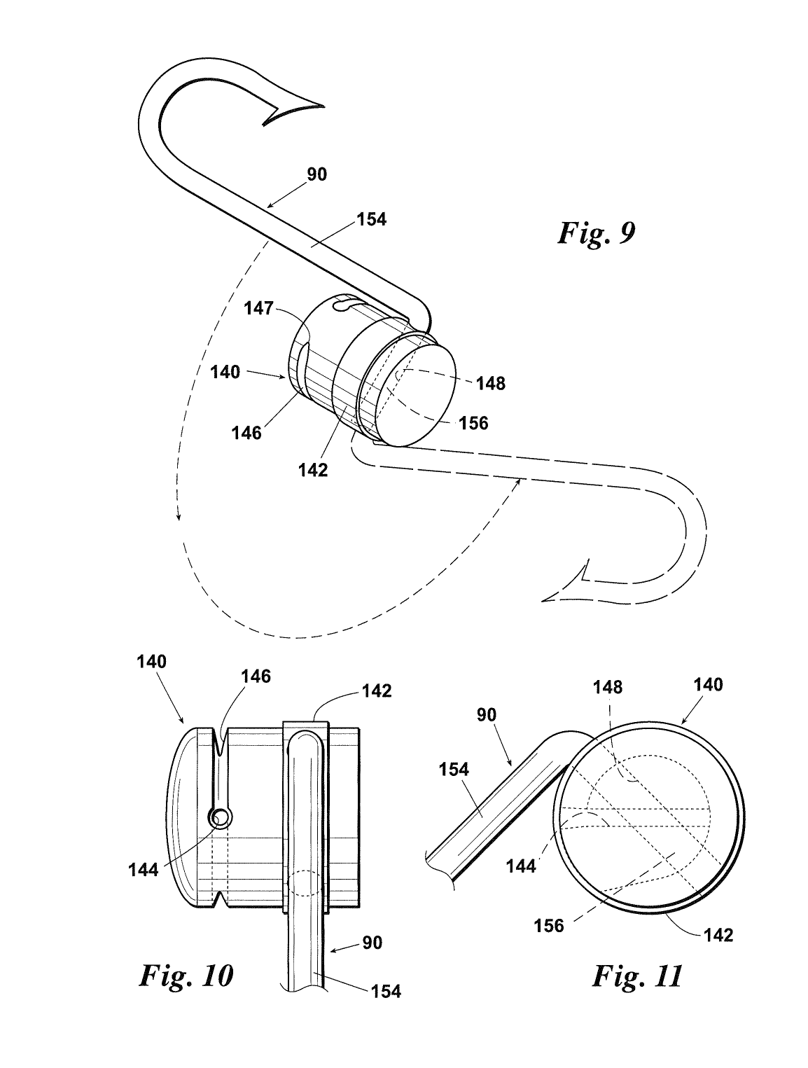

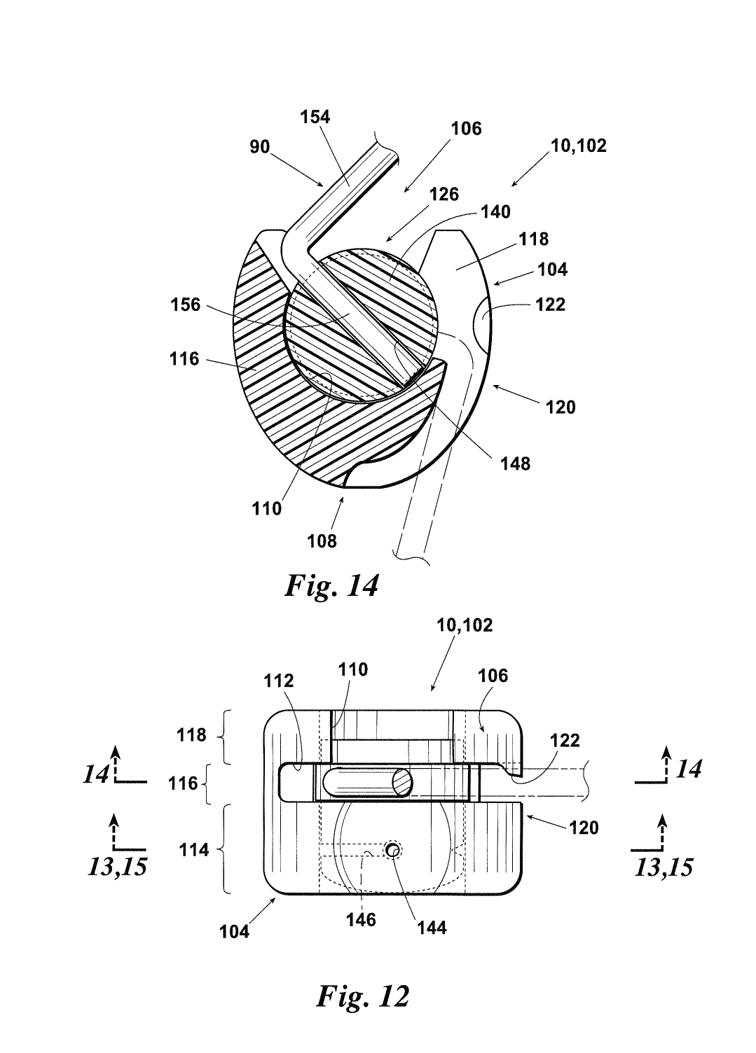

Referring now to FIGS. 1-14, shown is a device, designated generally 10, for affixing terminal tackle. In a first axially rotating embodiment 12 a body 14 includes an upper housing 16 and a lower housing 18. Upper housing 16 and lower housing 18 are shown connected to one another with screws. However, other methods of connection may also be used, including snap fit, ultra-sonic welding, adhesives, or other suitable methods. Upper housing 16 defines an upper line orifice 20 and an exterior funnel shaped indentation 22 for guiding fishing line 24 into upper line orifice 20. Upper housing 16 further defines an upper mating surface 26 on a lower end of upper housing 16 and an upper half of an internal cavity 28. Internal cavity 28 is preferably cylindrical.

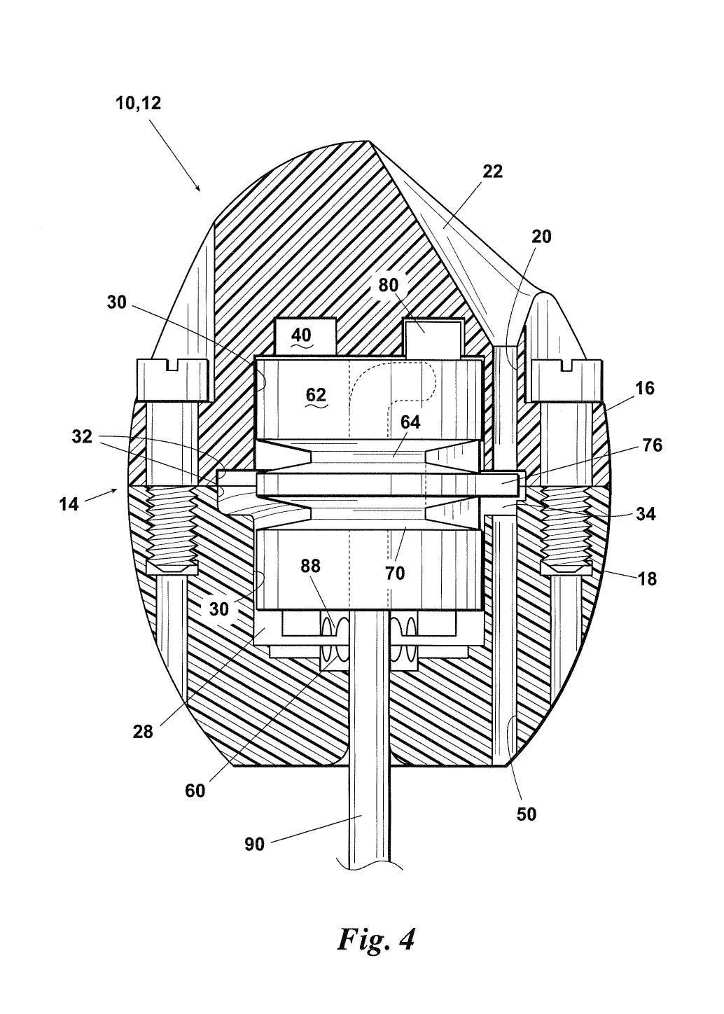

Referring now to FIGS. 1 and 4, inside upper housing 16, internal cavity 28 has a first portion 30 having a first radius and a second portion 32 having a second radius. The portion 32 of internal cavity 28 having the second radius defines an upper half of annular space 34 (FIG. 4) that surrounds internal cavity 28 proximate upper mating surface 26.

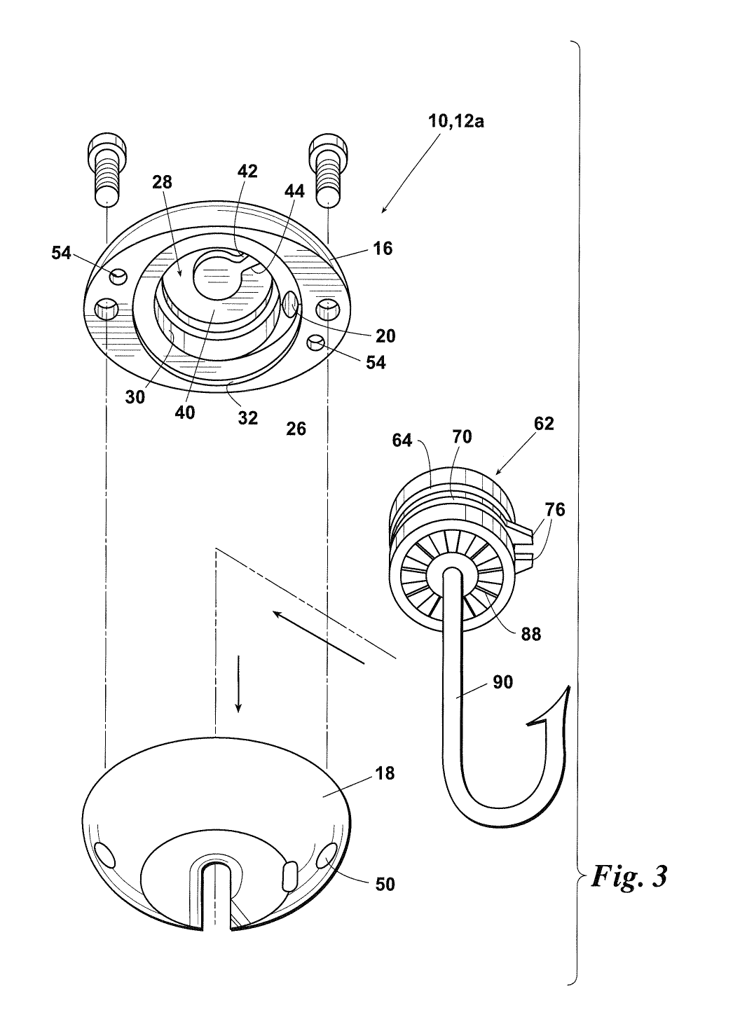

Exteriorly, upper housing 16 has a width 36 of a different dimension that a length 38 of upper housing 16 to form an easily grippable object. Interiorly, upper housing 16 further defines a recessed area 40 on an inner upper surface. Recessed area 40 has a first end 42 and a second end 44 (FIG. 3).

Lower housing 18 defines a lower line orifice 50 and a lower mating surface 52 on upper end of lower housing 18. Lower housing 18 further defines a lower half of internal cavity 28, which has a first portion 30 having a first radius and a second portion 32 having a second radius. The portion 32 having the second radius defines a lower half of annular space 34, which is proximate lower mating surface 52. Lower housing 18 also has a width 36 of a different dimension than length 38 (FIG. 7) to match the width 36 and length 38 of upper housing 16 to facilitate ease of gripping by a user. Mating features 54, e.g., mating pins and orifices, are provided to ensure proper alignment of upper housing 16 and lower housing 18.

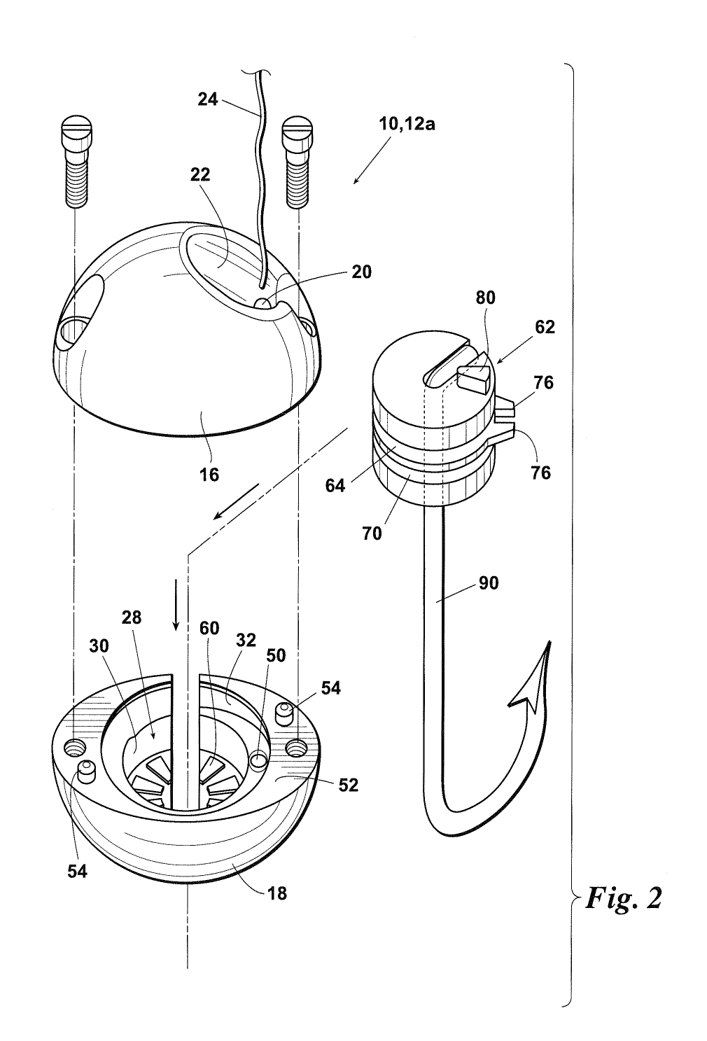

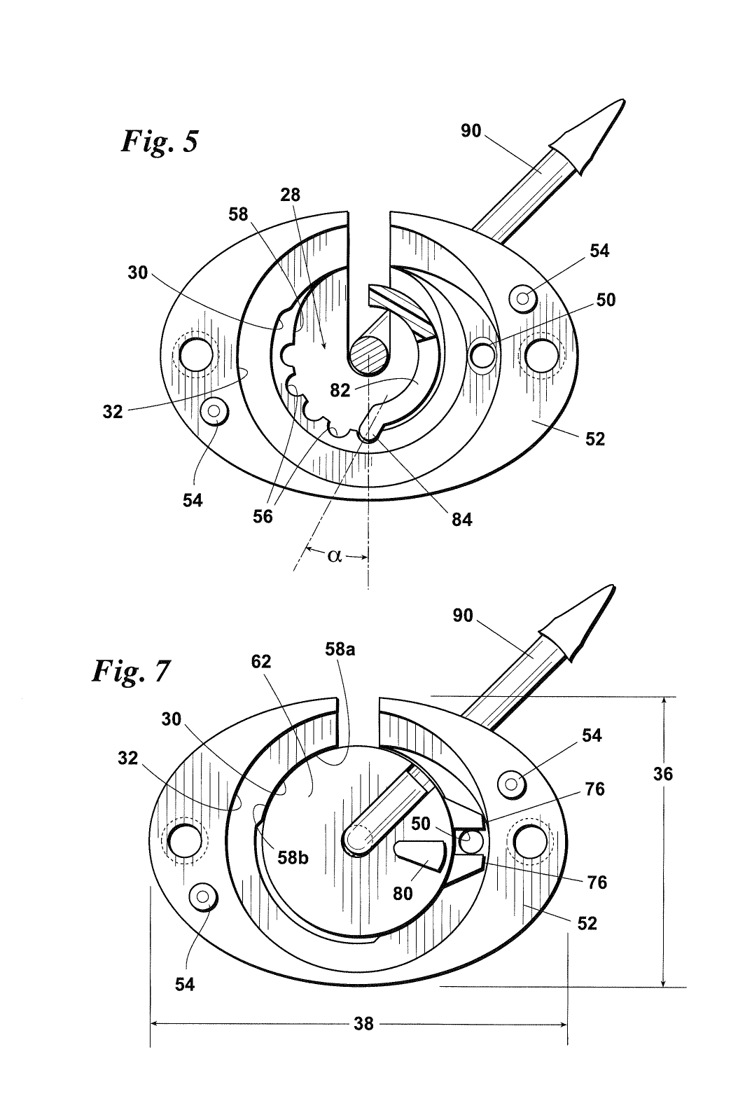

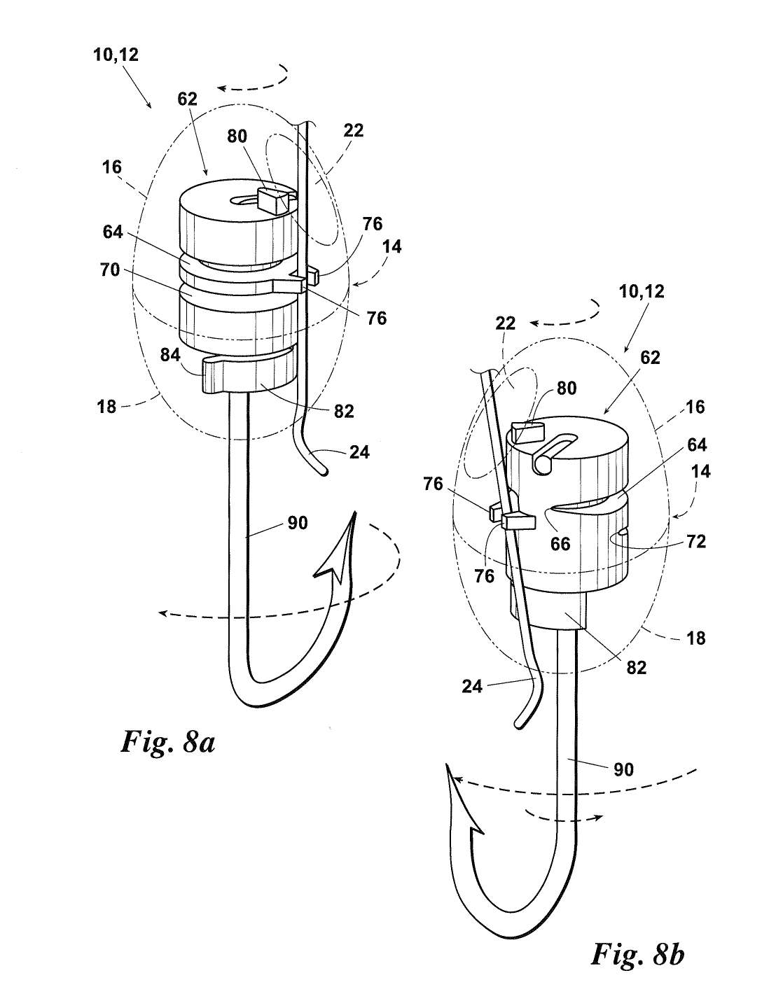

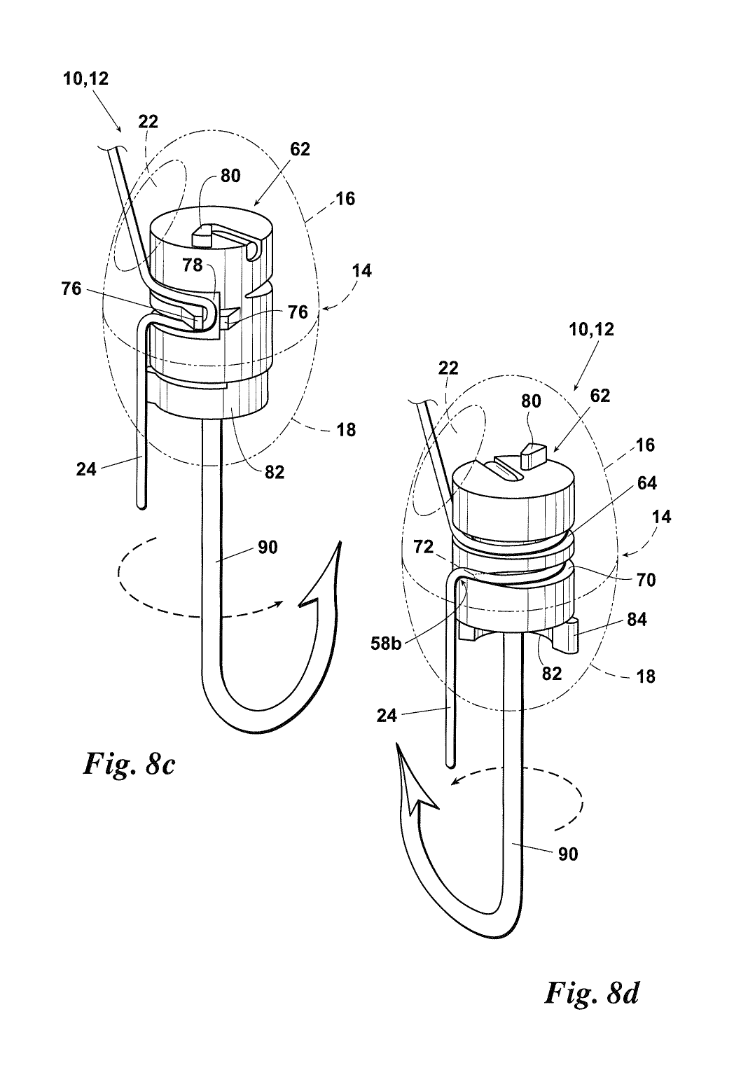

In one embodiment (FIG. 5), an inside of lower housing 18 defines a plurality of recesses 56 that are adjacent one another proximate a lower end of internal cavity 28. A pinch surface 58a is provided adjacent to recesses 56. In a locked position, line 24 is pinched between pinching surface 58a of lower housing 18 and pinching surface 58b of capstan 62 (FIG. 8d). In a second axially rotating embodiment 12a, a lower surface defined by an inside of lower housing 28 defines a plurality of teeth 60 (FIG. 2).

Capstan 62, or spool, is located within internal cavity 28. For purposes of this application, “capstan” shall refer to an object for receiving a length of wrapped line. An example of an application using a capstan is as follows. An anchored section of line is secured at a fixed location. The line is then wrapped around the capstan. After wrapping the line to some degree around the capstan, the other end of the line is left unsecured. The effect of the capstan of this example is to reduce the line tension between the anchored segment and the exiting line segment proportional to the amount of line wrap(s), the shape of the capstan, and the friction coefficient between the capstan and the line material. Capstan 62 and internal cavity 28 are preferably cylindrical, although other shapes may be used, including oval, clover shaped, pear shaped, octagonal, hexagonal, or other shapes. Capstan 62 defines an upper circumferential groove 64 having a tapered end 66 and a deep end 68 and also defines a lower circumferential groove 70 having a tapered end 72 and a deep end 74. In a preferred embodiment, grooves 64, 70 referenced in this application are v-shaped and have walls that are angled between approximately 5° and 45°, more preferably at 10°, with respect to a radial plane of capstan 62, although other suitable angles may also be used. Additionally, other shaped grooves are contemplated, including grooves that are wider at a top portion and narrower at a bottom portion, terraced grooves having multiple faces at a desired angle, e.g., 10°, textured grooves, serrated grooves, and other grooves suitable for the purposes set forth in this application. The tapered walls allow for gripping of line 24 over a range of diameters, i.e., a larger line will rest in an upper portion of a groove, while a smaller line will rest in a deeper, narrower portion of the groove. Preferably, the material rubbing against line 24 has a coefficient of friction preferably having a range of 0.08 to at least 0.2, with 0.2 being preferred. By angling the side walls of the grooves, it has been found that the effective coefficient of friction may be increased by a factor of 5.8. Finally, it should be understood that grooves 64, 70 may have a flat or other shaped lower surface. Additionally, grooves 64, 70 can be smooth, have texture, ridges, etc.

Capstan 62 has a pair of fingers 76 that extend radially from capstan 62 into annular space 34 defined by upper housing 16 and lower housing 18. Capstan 62 further defines a longitudinal groove 78 between fingers 76 for connecting deep end 68 of upper circumferential groove 64 with deep end 74 of lower circumferential groove 70. Capstan 62 has a tab 80 protruding from an upper surface that is received in recessed area 40 of upper housing 16. First end 42 and second end 44 of recessed area 40 limit rotational travel of tab 80 thereby limiting rotational travel of capstan 62.

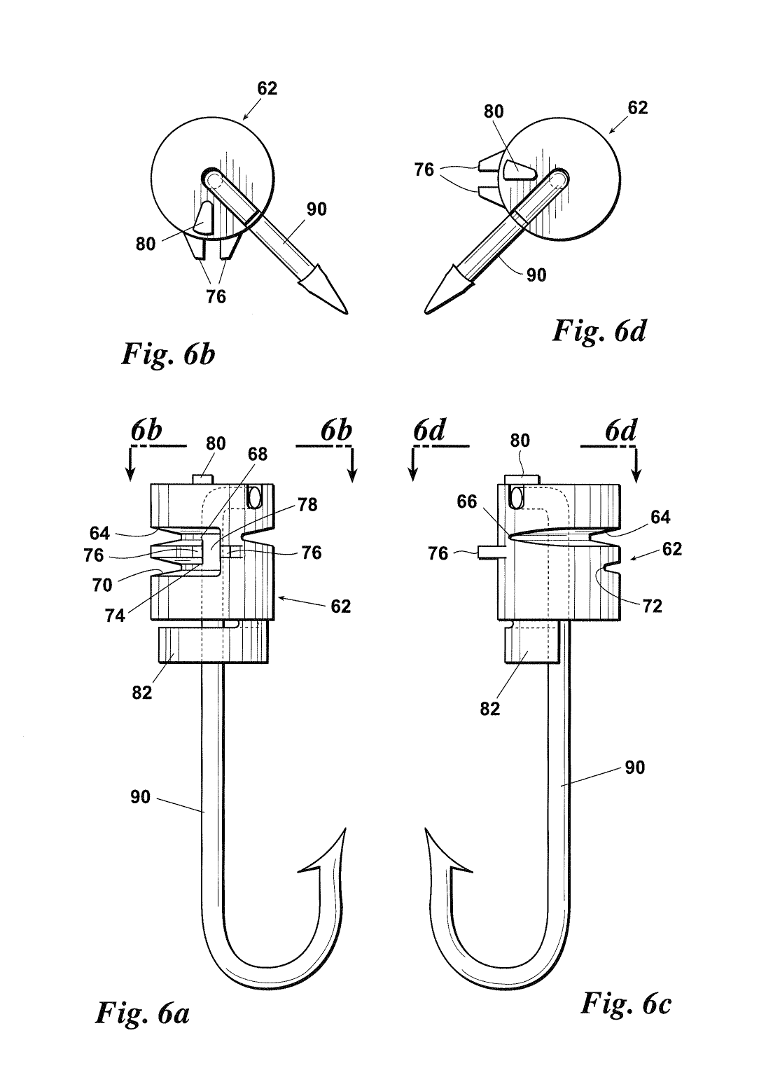

In embodiment 12, as shown in FIGS. 6a-6d, 7, and 8a-8d, a spring member 82 protrudes from a lower end of capstan 62. Spring member 82 has a knob 84 on a distal end thereof. Knob 84 is provided for engaging a selected one of the plurality of recesses 56 that are defined by lower housing 18 in the embodiment shown in FIG. 5 for maintaining capstan 62 at discreet rotational intervals. Knob 84 on spring member 82 preferably extends at an angle ∝ offset from a radial orientation with respect to capstan 62. Angle ∝ is preferably 20°, although other suitable orientations from 0° to 90° could also be used. Therefore, knob 84 is received within a selected one of recesses 56 at an angle ∝ such that rotation of capstan 62 is met with greater resistance when rotated in a first direction than when rotated in a second direction. Therefore, a user may rotate capstan 62 into a locked position more easily than the capstan 62 will rotate to an unlocked position.

In embodiment 12a (FIGS. 2, 3, 6e, 6f, and 7), a lower end of capstan 62 defines a plurality of downwardly facing teeth 88 (FIG. 3). Preferably, teeth 60 and 88 have a triangular cross section and sides that slope at 45°. Teeth 60 and 88 are preferably complementary for facilitating substantial engagement. However, other suitable teeth configurations may also be used. In this embodiment, capstan 62 has a length that is preferably less than a length of internal cavity 28 to allow for capstan 62 to move vertically within internal cavity 28. To accommodate the vertical movement of capstan 40, tab 80 must be of sufficient height to maintain the ability to contact ends 42 and 44 of upper housing 16. In embodiment 12a, annular space 34 spirals downwardly away from horizontal (best seen in FIG. 4). The sloping annular space is sloped down from a radial plane of capstan 62 to permit a downward movement of capstan 62 within internal cavity 28 by allowing fingers 76 to move downward in an expanded section of annular space 34 for forcing mating engagement of teeth 60 (FIG. 2) defined by a lower inside surface of lower housing 18 with downwardly facing teeth 88 (FIG. 3) defined by a bottom surface of capstan 62. Therefore, downward force on line 24 resulting from a fish catch also results in a tight engagement of teeth 60 with teeth 88, which results in an increased resistance to back drive of capstan 62.

Terminal tackle 90 is affixed to capstan 62 and is rotatable with capstan 62. Although terminal tackle 90 is shown as a fish hook in the examples, it should be understood that terminal tackle 90 may also be a weight, float, swivel, bobber, sinker, or other device.

Referring now to FIG. 7, capstan 62 is in a loading position wherein fingers 76 are in line with upper line orifice 20 and lower line orifice 50 (see FIGS. 4, 7, 8a). To affix device 12 to line 24, fishing line 24 is loaded through upper line orifice 20 of upper housing 16 and passes between fingers 76 and then out of lower line orifice 50. By rotating capstan 62 by twisting terminal tackle 90 relative to body 14, fingers 76 protruding from capstan 62 pull fishing line 24 out of alignment with upper line orifice 20 and lower line orifice 50 and pull line 24 into deep ends 68 and 74 of upper circumferential groove 64 and lower circumferential groove 70 (see FIG. 8c). As capstan 62 is further rotated with respect to body 14, fingers 76 continue to pull line 24 through a length of circumferential grooves 64 and 70 (see FIG. 8d). Additionally, line 24 in lower circumferential groove 70 is pulled past tapered end 72 (see FIG. 8d) where line 24 is forced between pinch surface 58a, 58b defined by an inner portion of lower housing 18 and an outer portion of capstan 62, which applies a pinching force to line 24. Capstan 62 is preferably rotated 300° to 330° to ensure that a substantial length of line 24 is located in grooves 64 and 70. By forcing line 24 into upper groove 64 and lower groove 70, the effective winding range is 485° to 530°. The longer the length of line 24 that is in contact with grooves 64 and 70, the greater the line tension is reduced, and thus the likelihood that line 24 will slip at the pinch/squeeze area 58a, 58b is reduced. Although a preferred range of line wrapping is provided above, it is contemplated that other ranges of line wrap could also be used to achieve the desired result.

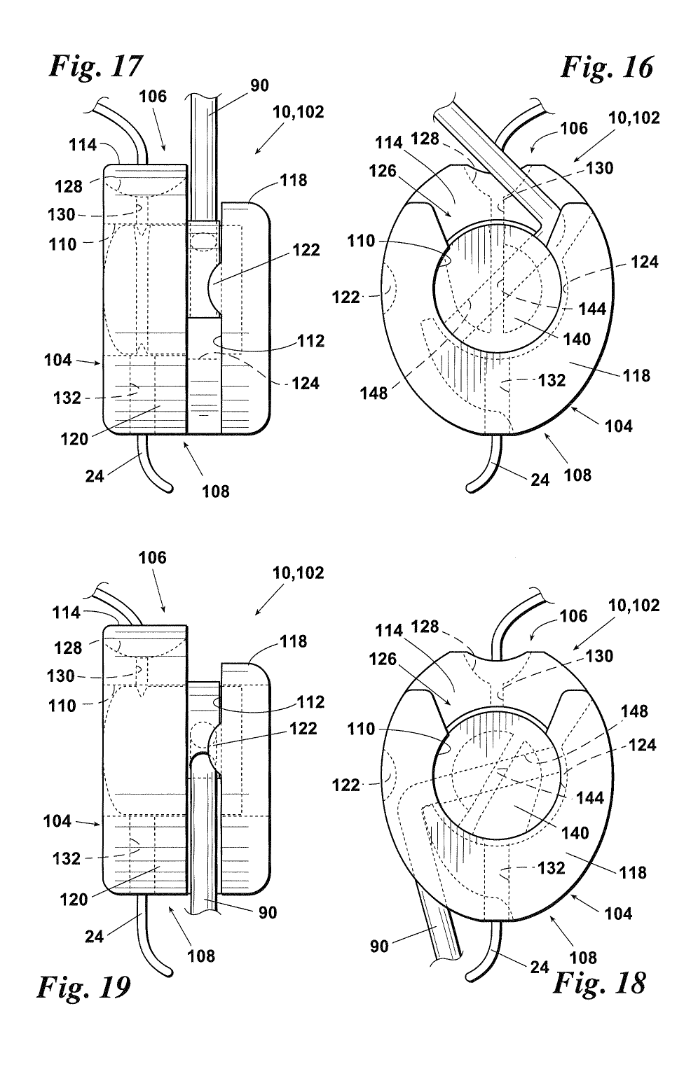

Now referring to FIGS. 9 through 19, shown is a third embodiment of device 10, designated generally 102. Third embodiment 102 includes a housing 104 having a top area 106 and a bottom area 108. Housing 104 defines a cylindrical cavity 110. Housing 104 additionally defines exterior slot 112 that partially divides housing 104 into a first exterior section 114, a mid section 116, and a second exterior section 118. Exterior slot 112 is located on a first side 120 of housing 104. Exterior slot 112 is in partial communication with cylindrical cavity 110. Second exterior section 118 further defines a protuberance 122 that extends into exterior slot 112. Housing 104 further defines an internal groove 124 located between first exterior section 114 and second exterior section 118. Internal groove 124 has a larger radius than that of the remainder of cylindrical cavity 110. Mid section 116 and second exterior section 118 define an open top area 126 on a first end.

First exterior section 114 further defines a funnel shaped section 128 that surrounds an entrance to upper line orifice 130. Upper line orifice 130 passes from an exterior surface to cylindrical cavity 110 on a second end.

A bottom area of first exterior section 114 defines a bottom line orifice 132. Bottom line orifice 132 passes from cylindrical cavity 110 at a first end to a lowermost portion of housing 104 at a second end. Upper line orifice 130 and bottom line orifice 132 are in line with one another.

Capstan 140 is sized to be located within cylindrical cavity 110. Capstan 140 defines a band 142 having a larger diameter than the remainder of capstan 140. Band 142 is provided for cooperative engagement with interior groove 124 of housing 104. Capstan 140 defines a passageway 144 that passes through capstan 140 when located in housing 104. Capstan 140 may be rotationally oriented to line up passageway 144 with upper line orifice 130 and bottom line orifice 132 when capstan 140 is in an open position (FIG. 17). Capstan 140 further defines a circumferential v-shaped groove 146 that surrounds a substantial portion of capstan 140. Capstan 140 is preferably rotatable through 150° to move capstan 140 from an open position to a closed position. Other suitable rotatable ranges may also be appropriate. Capstan 140 further defines a terminal tackle passageway 148 that passes through band 142 of winding member 140.

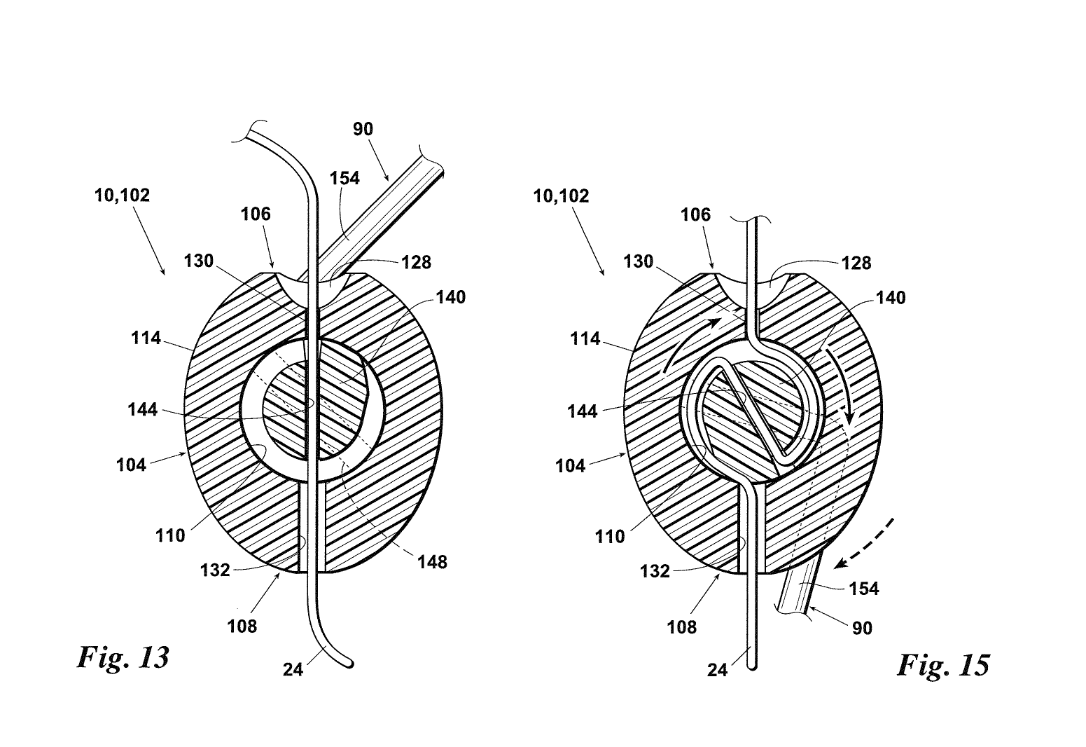

To install device 102 on fishing line 24, capstan 140 is rotated to an open position (FIG. 13). Fishing line 24 is inserted in upper line orifice 130 then passed through passageway 144 of capstan 140 to then pass through bottom line orifice 132. When capstan 140 is rotated within housing 104 from an open position to a closed position (FIG. 15), fishing line 24 is pulled through a length of circumferential groove 146 when capstan 140 is in a closed position. Fishing line 24 is wound around capstan 140 for 150° from each end of passageway 144, i.e., for a total winding length of 300°, which provides a substantial length of line 24 to frictionally engage with a length of groove 146. Other winding lengths may also be used. Fishing line 24 is further pinched between an outside of capstan 140 and an inside of housing 104 at an end 147 (FIG. 9) of groove 146 opposite where groove 146 communicates with passageway 144.

Terminal tackle member 90, such as a fishing hook, is provided with a long stem 154 that is connected to an insert stem 156 by a 90° bend. Insert stem 156 is received within terminal tackle passageway 148 of capstan 140. Terminal tackle member 90 may be used to rotate capstan 140 with respect to housing 104. During travel from an open position to a closed position, a portion of insert stem 156 of terminal tackle member 152 will briefly engage protuberance 122 to provide tactile feedback when capstan 140 has achieved a fully locked or fishing position. Second exterior section 118 that is adjacent to protuberance 122 permits flexure so that second exterior section 118 may spring away from protuberance 122 when terminal tackle member 90 passes between protuberance 122 and second exterior section 118. Open top area 126 of second exterior section 118 facilitates the flexing of second exterior section 118 as required. Open top area 126 further facilitates insertion of terminal tackle member 90 during assembly of second embodiment 102.

In the closed position, snap terminal tackle 102 may resemble a standard hook where a typical hook eyelet is replaced by the present invention. The hook portion attaches to the invention such that it can be used as the primary means for rotating the invention into the locked position.

The invention adjusts for the change in line diameter as the fishing line 24 is stretched by pivoting capstan 140 about its axis due to load applied by fish in the direction of the arrow in FIG. 15.

The invention requires that the force of friction be overcome for line 24 to slip out of the mechanism. Friction in all contact areas works against the direction of slip, providing better retention with the mechanism.

All of the above described embodiments are contemplated as being reusable. Once capstan 62, 140 is rotated back from a closed position to an open position, line 24 is released from frictional contact and may be easily removed.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

1-38. (canceled)

39. A device for affixing terminal tackle to a fishing line comprising:
a body having a chamber therein and an upper orifice;
a capstan within said chamber, said capstan having an at least partial circumferential groove;
a terminal tackle affixed to said capstan;
wherein a fishing line will pass through said upper orifice and contact said capstan; and
wherein said capstan may be rotated within said body for displacing a path of said fishing line for forcing said fishing line into said groove for at least partially wrapping said line around said capstan for increasing a length of engagement between said fishing line and said capstan for securing said body onto said line.

40. The device according to claim 39 wherein:
said body further includes a lower orifice through which said fishing line is receivable such that said fishing line will pass out of said lower orifice.

41. The device according to claim 39 further comprising:
a pinch point defined between said capstan and an interior surface of said body for securing said fishing line.

42. The device according to claim 39 wherein:
said terminal tackle includes a stem having a longitudinal axis; and
said capstan is rotatable about said longitudinal axis of said stem.

43. The device according to claim 39 wherein:
said terminal tackle has a stem positioned within said capstan on a radial plane of said capstan; and
said terminal tackle is rotatable about a longitudinal axis of said capstan.

44. The device according to claim 39 wherein:
said groove is a v-shaped groove.

45. The device according to claim 39 wherein:
said groove has two diverging side walls, each of said walls being orientated at an angle of between approximately 5° and approximately 40° with respect to a radial plane of said capstan.

46. The device according to claim 39 further comprising:
a finger protruding from said capstan, said finger positioned to sweep across said path of said fishing line when said fishing line is passed through said upper orifice for pulling said fishing line into said groove of said capstan.

47. The device according to claim 46 further comprising:
an annular space provided in said body for accommodating travel of said finger as said capstan is rotated.

48. The device according to claim 47 wherein:
said annular space has a lower surface that angles downwardly to facilitate longitudinal movement of said capstan when said capstan is rotated to a closed position.

49. The device according to claim 39 further comprising:
a protrusion defined by said body that partially impedes travel of said terminal tackle with respect to said body, said protrusion providing tactile feedback when said terminal tackle is positioned to a pre-determined location.

50. The device according to claim 39 wherein:
said body includes a plurality of interior recesses;
said capstan has a spring member protruding therefrom for clicking engagement with said recesses.

51. The device according to claim 50 wherein:
said spring member is provided with a knob on a distal end thereof, wherein said knob of said spring member engages said recesses;
said knob is offset from a radial orientation with respect to said capstan for providing more resistance when said capstan is rotated in a first direction than when said capstan is rotated in a second direction.

52. The device according to claim 39 wherein:
said body includes a plurality of teeth within said cylindrical chamber at a bottom end thereof;
said capstan includes a plurality of teeth on a bottom end of said capstan for engagement with said teeth within said chamber to prevent backdrive of said capstan when tension is applied to said line.

53. The device according to claim 39 wherein:
said capstan defines a passageway passing through said capstan on a radial plane, said passageway for receiving said fishing line;
wherein rotation of said capstan displaces a path of said fishing line and forces said fishing line into said groove at locations proximate a first end of said passageway and a second end of said passageway.

54. A method for affixing terminal tackle to a fishing line comprising the steps of:
inserting a fishing line into an upper orifice of a body; and
rotating a capstan inside of said body for forcing said fishing line into a circumferential groove provided in said capstan and for at least partially wrapping said fishing line around said capstan for increasing contact area between said fishing line and said capstan for securing said body onto said fishing line.

55. The method according to claim 54 wherein:
said step of inserting further comprises exiting said fishing line from a lower orifice of said body; and
said step of rotating said capstan displaces a path of said fishing line.

56. The method according to claim 54 further comprising:
pinching said fishing line between said capstan and an interior surface of said body for securing said line.

57. The method according to claim 54 wherein:
said step of rotating said capstan comprises grasping a terminal tackle affixed to said capstan, wherein said terminal tackle has a stem that is substantially collinear with a longitudinal axis of said capstan, and rotating said stem of said terminal tackle.

58. The method according to claim 54 wherein:
said step of rotating comprises grasping a terminal tackle affixed to said capstan and revolving said terminal tackle about a longitudinal axis of said capstan.

59. The method according to claim 55 wherein said step of displacing a path of said fishing line comprises the step of:
sweeping a finger protruding from said capstan across said path of said fishing line for pulling said fishing line into said groove of said capstan.

60. The method according to claim 59 wherein:
said finger sweeps through an annular space provided in said body for accommodating travel of said finger as said capstan is rotated.

61. The method according to claim 54 further comprising the steps of:
providing tactile feedback with respect to a rotational orientation of said capstan by clicking a spring member extending from said capstan into a plurality of recesses provided in said body.

62. The method according to claim 54 further comprising:
preventing backdrive of said capstan when tension is applied to said line.

63. The method according to claim 62 further comprising the steps of:
allowing said capstan to move longitudinally when tension is applied to said fishing line for engaging teeth on a lower surface of said capstan with corresponding teeth provided within said body.

64. The method according to claim 54 wherein:
said step of inserting further comprises passing said fishing line through a passageway extending through said capstan; and
said step of rotating said fishing line comprises forcing said line into said groove at locations proximate a first end of said passageway and a second end of said passageway.

65. A capstan for use in a terminal tackle device comprising:
a capstan body having a circumferential groove;
wherein, upon rotation of said capstan body, fishing line is directed into said circumferential groove for providing a length of line in frictional contact with said groove.

66. The capstan according to claim 65 wherein:
said capstan body is cylindrical.

67. The capstan according to claim 65 wherein:
said groove is an upper groove; and
said capstan body further has a lower groove.

68. The capstan according to claim 65 wherein:
said groove is v-shaped.

69. The capstan according to claim 65 wherein:
walls of said groove slope inwardly at between 5° and 45° with respect to a radial plane of said capstan body.

70. The capstan according to claim 69 wherein:
said walls of said groove have a 10° slope.

71. A method for affixing terminal tackle to a fishing line comprising the steps of:
feeding a line into a device having a capstan and a body, said device affixed to terminal tackle;
rotating said capstan within said body for locating said line into a groove provided on an exterior of said capstan;
pinching said line between said capstan and said body for securing said terminal tackle to said line.

72. The method according to claim 71 wherein said step of rotating said capstan comprises rotating said capstan 250° to 330°.

73. A device for affixing terminal tackle to a fishing line comprising:
a body;
a capstan rotatably mounted in said body, said capstan having a groove on an exterior of said capstan, wherein said groove receives a length of fishing line;
wherein said capstan is rotatable by said attached terminal tackle.

74. The device according to claim 73 wherein said capstan has a circular cross section.

75. The device according to claim 73 wherein said capstan has an oval cross section.

76. The device according to claim 73 wherein:
rotating said capstan pinches the line between said capstan and said body.

77. The device according to claim 73 wherein:
terminal tackle is a fishing hook.

78. A line attachment device comprising:
a housing including a first line-receiving orifice having an outlet end within said housing, a second line-receiving orifice having an inlet end within said housing and spaced apart from said outlet end of said first line-receiving orifice, and an interior cavity, and
a gripping/locking/rotatable structure positioned in said interior cavity for rotation between an open position and a closed position,
wherein, when said gripping structure is in said open position, a loading path is provided in said housing for delivering a line through said first line-receiving orifice and into said second line-receiving orifice, and
wherein, when said gripping structure is rotated from said open position to said closed position, a portion of said line will be pulled at least partially around said gripping structure such that said line will be gripped/locked between said gripping structure and at least one internal surface of said interior cavity.

79. The line attachment device of claim 78 wherein said first and said second line-receiving orifices are colinear.

80. The line attachment device of claim 78 wherein, when said gripping structure is rotated from said open position to said closed position, said portion of said line will be pulled out of said loading path.

81. The line attachment device of claim 78 wherein said gripping structure has at least one outer groove in which said line is received when said gripping structure is rotated from said open position to said closed position.

82. The line attachment device of claim 81 wherein said gripping structure further includes a pinching surface adjacent a terminal end of said groove for pinching said line against a corresponding internal pinching surface in said interior cavity.

83. The line attachment device of claim 78 further comprising a finger projecting from said gripping structure for engaging said line when said gripping structure is rotated from said open position to said closed position and pulling said portion of said line at least partially around said gripping structure.

84. The line attachment device of claim 78 wherein:
said gripping structure includes a line-receiving orifice extending therethrough, and
said line-receiving orifice of said gripping structure will be positioned in said loading path for receiving said line when said gripping structure is in said open position.

85. The line attachment device of claim 84 wherein, when said gripping structure is rotated from said open position to said closed position, said line-receiving orifice of said gripping structure will engage said line in a manner effective for pulling said portion of said line at least partially around said gripping structure.

86. The line attachment device of claim 85 wherein, when said gripping structure is in said open position, said line-receiving orifice of said gripping structure will be colinear with said first and said second line-receiving orifices of said housing.
